(19) United States
(12) Patent Application Publication
(10) Pub. No.: US 2008/0097632 A1
(43) Pub. Date: Apr. 24, 2008

(54) Handheld device, integrated circuit and methods for playing sponsor information with the playback of program content

(76) Inventor: Cullen A. Logan, Austin, TX (US)

Correspondence Address: GARLICK HARRISON & MARKISON, P.O. BOX 160727, AUSTIN, TX, 78716-0727, US

(21) Appl. No.: 11/544,501

(22) Filed: Oct. 6, 2006

(51) Int. Cl. G06F 17/00

(52) U.S. Cl. 700/94

(57) ABSTRACT

A handheld device includes a memory that stores a digitally formatted file, the digitally formatted file having a first portion that includes program content and a second portion that includes sponsor information. A playback module, coupled to the memory, plays the digitally formatted file by generating an analog audio signal and/or video signal.

### BACKGROUND OF THE INVENTION

1. Technical Field of the Invention

The present invention relates to handheld audio/video players that playback digitally formatted files.

2. Description of Related Art

Integrated circuits have enabled the creation of a plethora of handheld devices, however, to be “wired” in today's electronic world, a person needs to posses multiple handheld devices. For example, one may own a cellular telephone for cellular telephone service, a personal digital assistant (PDA) for scheduling, address book, etc., one or more thumb drives for extended memory functionality, a motion picture expert group (MPEG) audio layer 3 (MP3) player for storage and/or playback of digitally recorded music, a radio, etc. Thus, even though a single handheld device may be relatively small, carrying multiple handheld devices on one's person can become quite burdensome.

Currently, sponsor promotions allow a winner of a sweepstakes or contest to receive a prize code that enables a user to access a website and download a digital music file of their choice, free of charge. This digital music file can then be transferred to a handheld audio player such as an MP3 player for playback. While the playback of the music can be repeated many times, the association of the free music with the sponsor and the sponsors products ends after the music is downloaded to the audio player.

Therefore, a need exists for handheld devices that provide greater functionality and features.

### BRIEF DESCRIPTION OF THE SEVERAL VIEWS OF THE DRAWINGS

FIG. 1 presents a pictorial representation of a handheld device 80 in accordance with an embodiment of the present invention.

FIG. 2 presents a block diagram representation of handheld device 80 in accordance with an embodiment of the present invention.

FIG. 3 presents a block diagram representation of memory module 40 in accordance with an embodiment of the present invention.

FIG. 4 presents a block/schematic diagram representation of a multimedia module in accordance with an embodiment of the present invention.

FIG. 5 presents a block diagram representation of a multimedia interface 52 in accordance with an embodiment of the present invention.

FIG. 6 presents a pictorial representation of a wireless handset 150 in accordance with an embodiment of the present invention.

FIG. 7 presents a block diagram representation of wireless handset 150 in accordance with an embodiment of the present invention.

FIG. 8 presents a block/pictorial diagram of a host interface 18 in accordance with an embodiment of the present invention.

FIG. 9 presents block/pictorial representation of transceiver module 30 in accordance with an embodiment of the present invention.

FIG. 10 presents a block diagram representation of a text message interface 90 in accordance with an embodiment of the present invention.

FIG. 11 presents pictorial representation of several screen displays in accordance with an embodiment of the present invention.

FIG. 12 presents pictorial representation of several screen displays in accordance with an embodiment of the present invention.

FIG. 13 presents pictorial representation of several screen displays in accordance with an embodiment of the present invention.

FIG. 14 presents a flowchart representation of a method in accordance with an embodiment of the present invention.

FIG. 15 presents a flowchart representation of a method in accordance with an embodiment of the present invention.

FIG. 16 presents a flowchart representation of a method in accordance with an embodiment of the present invention.

FIG. 17 presents a flowchart representation of a method in accordance with an embodiment of the present invention.

FIG. 18 presents a flowchart representation of a method in accordance with an embodiment of the present invention.

### DETAILED DESCRIPTION OF THE INVENTION

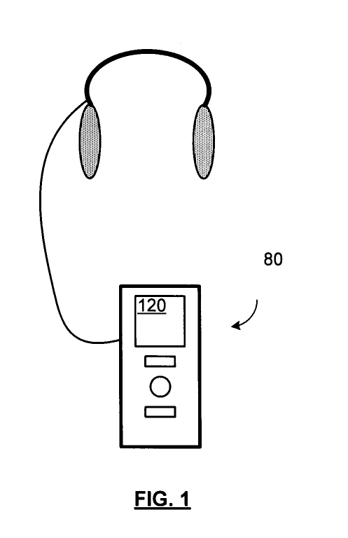

FIG. 1 presents a pictorial representation of a handheld device 80 in accordance with an embodiment of the present invention. In particular, handheld device 80 includes an audio player such as an MP3 player for processing the storage and/or playback of the digitally formatted audio data such as songs, audio books, audio clips or educational materials. Handheld device 80 includes a display device 120, such as a color video display, and one or more buttons, click wheels and/or other user activated devices that provide a user interface. In addition, handheld device 80 can include an optional video player that processes the storage and/or playback of digitally formatted video content such as movies, television shows, video clips, educational materials or other video content on display device 120.

In an embodiment of the present invention, a sponsor such as a retailer, product manufacturer or distributor or service provider creates a digitally formatted file, such as a compressed audio or video file, that has a first portion that includes program content, and a second portion that includes sponsor information. The program content can be an audio program such as an album, audio book or portion thereof or song that is formatted in a compressed audio format such as MP3, MP4, WMA—Windows Media Architecture, AAC—Advanced Audio Coding, or other format or a digitally formatted video clip or video program, either compressed or uncompressed. The sponsor information includes an audio advertisement, text, graphics, still images and/or video.

The user of the handheld device 80 can download the digitally formatted file from the sponsor's website, third party website or other source and store the digitally formatted file on the handheld device. The digitally formatted file can be sold at a reduced price, compared with other program content, particularly when compared with similar program content that does not include the sponsor information, or offered for free. Further, the digitally formatted file can be downloaded by winners of a sweepstakes, contest, or other promotion to users that have a valid prize code, promotion code or coupon code, that can be entered by the user and authenticated by the website as a valid code, prior to download.

When the handheld device plays the program content from the digitally formatted file, the handheld device 80 displays the sponsor information in conjunction therewith. For example, the playback of song sponsored by Very Berry Cola, may be accompanied by the playback of an audio advertisement for Very Berry Cola that is placed before, after or during the playback of the song. Alternatively or in addition, the display device 120 can display sponsor information in the form of text, graphics, still images and/or video in conjunction with the playback of the song. In this fashion, the user is reminded of the sponsor, the sponsors products or the sponsors other message when the song is played.

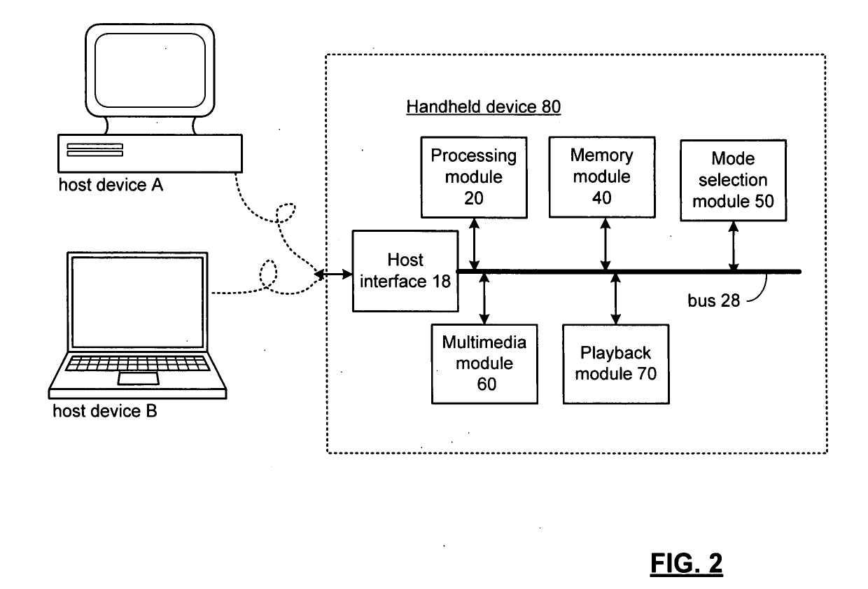

Further details, including several alternative implementations and additional functions and features of the present invention are described further in conjunction with FIGS. 2-18 that follow.

FIG. 2 presents a block diagram representation of handheld device 80 in accordance with an embodiment of the present invention. In particular, handheld device 80 includes a processing module 20 and memory module 40 that communicate via bus 28. In an embodiment of the present invention, processing module 20 includes a processor for executing a series of operational instructions such as system programs, application programs, and other routines.

The processor of processing module 20 can be implemented using a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in memory. Note that when the processing module 20 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. Further note that, the memory module 40 stores, and the processing module 20 executes, operational instructions corresponding to at least some of the steps and/or functions illustrated herein.

The memory module 40 may be a single memory device or a plurality of memory devices. Such a memory device may be a read-only memory, random access memory, volatile memory, non-volatile memory, static memory, dynamic memory, flash memory, cache memory, and/or any device that stores digital information.

In addition, handheld device 80 includes host interface 18 for selectively coupling handheld device 80 to a host device. When the handheld device 80 is operably coupled to a host device A, or B which may be a personal computer, workstation, server (which are represented by host device A), a laptop computer (host device B), a personal digital assistant and/or any other device that may transceive data. with the multi-function handheld device, the mode selection module 50 places the integrated circuit 12 in a host connected mode. In particular, host device A or B can transfer a digitally formatted file that includes both program content and sponsor information to handheld device 80.

When the handheld device 80 is in the host connected mode, the host interface 18 facilitates the transfer of data between the host device A or B and handheld device 80. For example, data received from the host device A, or B is first received via the host interface 18. Depending on the type of coupling between the host device and the handheld device 80, the received data will be formatted in a particular manner. For example, if the wireless handset is coupled to the host device via a USB cable, the received data will be in accordance with the format proscribed by the USB specification. The host interface 18 converts the format of the received data (e.g., USB format) into a desired format by removing overhead data that corresponds to the format of the received data and storing the remaining data as data words. The size of the data words generally corresponds directly to, or a multiple of, the bus width of bus 28 and the word line size (i.e., the size of data stored in a line of memory) of memory 16. Under the control of the processing module 20, the data words are provided to memory module 40 for storage. In this mode, the handheld device 80 is functioning as extended memory of the host device (e.g., like a thumb drive).

In furtherance of the host connected mode, the host device may retrieve data from memory module 40 as if the memory were part of the computer. Accordingly, the host device provides a read command to the handheld device 80, which is received via the host interface 18. The host interface 18 converts the read request into a generic format and provides the request to the processing module 20. The processing module 20 interprets the read request and coordinates the retrieval of the requested data from memory module 40. The retrieved data is provided to the host interface 18, which converts the format of the retrieved data from the generic format of the handheld device 80 into the format of the coupling between the wireless handset and the host device. The host interface 18 then provides the formatted data to the host device via the coupling.

The coupling between the host device and the handheld device 80 may be a wireless connection or a wired connection. For instance, a wireless connection, provided by a wireless transceiver included in host interface 18 can provide a wireless link in accordance with Bluetooth, IEEE 802.11x, ultra-wideband (UWB), Wimax and/or any other wireless LAN (local area network) protocol, IrDA, etc. The wired connection may be in accordance with one or more Ethernet protocols, Firewire, USB, etc. Depending on the particular type of connection, the host interface 18 includes a corresponding wired or wireless transceiver including a corresponding encoder and decoder. For example, when the handheld device 80 is coupled to the host device via a USB cable, the host interface 18 includes a USB encoder and a USB decoder.

As one of average skill in the art will appreciate, the data stored in memory module, which may have 64 Mbytes or greater of storage capacity, may be text files, presentation files, user profile information for access to various computer services (e.g., Internet access, email, etc.), digital audio files (e.g., MP3 files, WMA—Windows Media Architecture—, mp3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format.

In an embodiment of the present invention, when the handheld device 80 is coupled to the host device A or B via a wired connection or direct coupling, the host device may power the wireless device 150 such that the battery is unused and/or may further recharge the battery of wireless device 150. When the handheld device 80 is uncoupled from the host device, the mode selection module 50 detects the disconnection and places the wireless handset in an alternative operational mode.

In accordance with an embodiment of the present invention, the playback module 70 includes an audio/video player such as an audio/video MP3 player for processing the storage and/or playback of the digitally formatted audio data such as songs, audio books, audio clips or educational materials and/or digitally formatted video files in a compressed video format and that generates an analog audio signal for an internal speaker, an external speaker or for headphones or earbuds that are coupled to handheld device 80 and optionally a video signal for display device 120. In an alternative embodiment of the present invention, playback module processes the playback of an audio and/or video channel derived from a streaming audio signal, or a streaming video signal from a file that is stored remotely from the handheld device 80. In a further embodiment of the present invention, playback module processes the playback of an audio channel derived from a video signal from a file containing video content such as a movie, home video, video clip, or video file captured by handheld device 80, that is stored in memory module 40. In addition, playback module can produce a streaming digital audio or video signal from a digitally formatted file that is transferred to an external device such as a Bluetooth headset over host interface 18 or other Bluetooth link or to other devices over a short range wireless connection or over a wired connection.

Mode selection module 50 places the handheld device 80 in one of a plurality of modes, such as a host connected mode, audio playback mode, video playback mode, voice recording mode, image capture mode, etc. based on either the state of handheld device 80, such as being connected to the host, or based on a selection of the user via a user interface provided by multimedia module 60.

Each of these modules may be implemented in hardware, firmware, software or a combination thereof, in accordance with the broad scope of the present invention. While a particular bus architecture is shown in FIG. 2, alternative bus architectures that include further connectivity, such as direct connectivity between the various modules, are likewise possible to implement the features and functions included in the various embodiments of the present invention.

In operation, memory module 40 stores a digitally formatted file such as a compressed or uncompressed audio file or a compressed or uncompressed video file , the digitally formatted file having a first portion that includes program content and a second portion that includes sponsor information. Playback module 70 plays the digitally formatted file by generating an analog or digital audio signal and/or analog or digital video signal, from the program content for an internal speaker, external speaker or headphones, display 120 etc and further by playing the sponsor information, either as audio, video, text and/or graphics. In an embodiment of the present invention, the sponsor information includes an audio or video advertisement that is appended to the program content and wherein playback module plays the program content and plays the advertisement in conjunction therewith. In this fashion, the advertisement is played by playback module 70 preferably before, but optionally after the playback of the program content or during the playback of the program content, such as during a break between songs, when the program content includes a plurality of songs, such as an album or other collection. Further or in addition, the handheld device 80 can display sponsor information as text, graphics, video or still images on the display 120 of handheld device 80.

In an embodiment of the present invention, some or all of the modules of handheld device 80 can be implemented on an integrated circuit such as a system on a chip (SoC) integrated circuit that provides the corresponding functions described herein. Such an integrated circuit can include a memory that stores a digitally formatted file the digitally formatted file having a first portion that includes program content and a second portion that includes sponsor information. The integrated circuit can further include a playback module, coupled to the memory, that plays the digitally formatted file by generating a signal, such as an analog or digital audio signal or an analog or digital video signal that is based on the program content and by playing the sponsor information, either as audio, video, text and/or graphics.

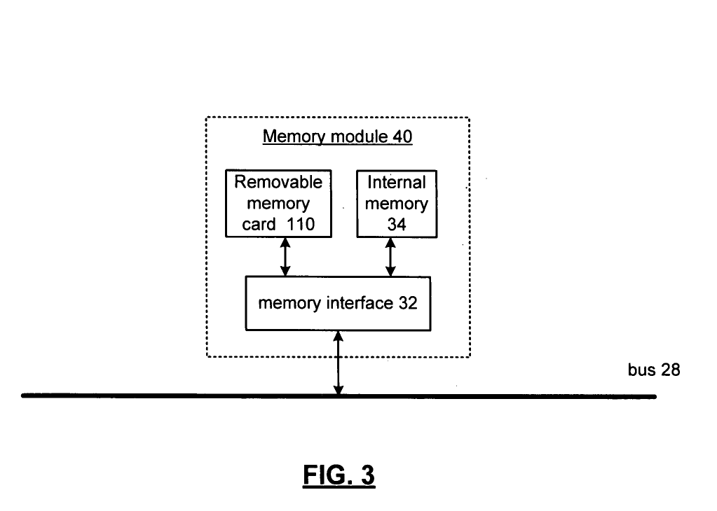

FIG. 3 presents a block diagram representation of memory module 40 in accordance with an embodiment of the present invention. In particular, memory module 40 includes a memory interface 32 for accessing an internal memory 34 that may include one or more memory chips and one or more removable memory cards 110. In an embodiment of the present invention, removable memory card 110 can include non-volatile memory in a format such as CompactFlash, SmartMedia, Memory Stick, Secure Digital (SD) card, xD card or other memory card format. In an embodiment of the present invention, removable memory card 110 can store data such as the digitally formatted files discussed in conjunction with FIGS. 1 and 2, text files, presentation files, user profile information for access to various computer services (e.g., Internet access, email, etc.), other digital audio files (e.g., MP3 files, WMA—Windows Media Architecture—, mp3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format.

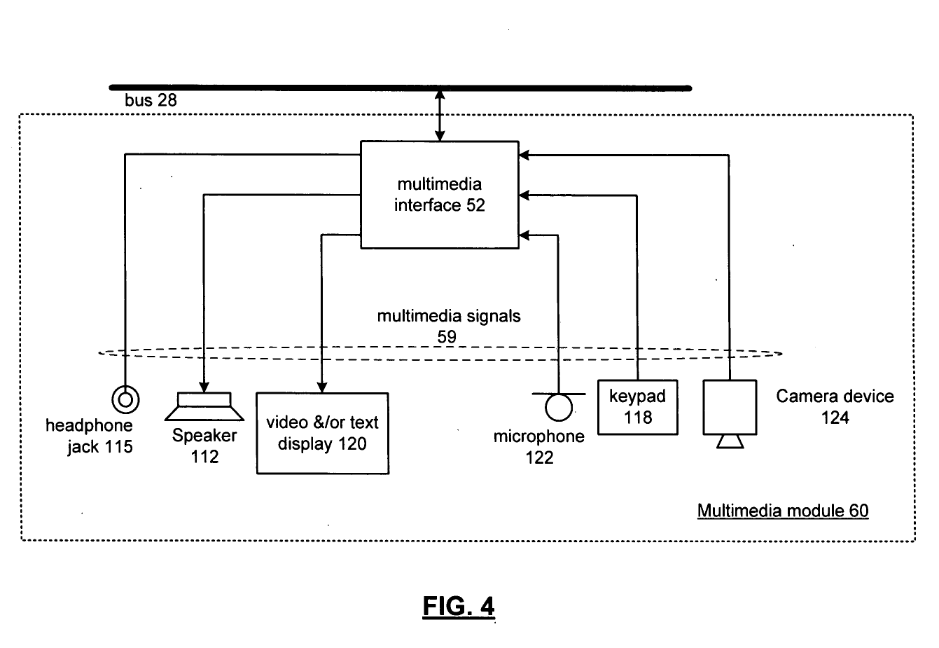

FIG. 4 presents a block/schematic diagram representation of a multimedia module in accordance with an embodiment of the present invention. In particular, multimedia module 60 includes a multimedia interface 52 for providing multimedia signals to and from a variety of input/output devices including headphones 116 via headphone jack 115, speaker 112, video and/or text display 120, microphone 122, keypad 118 and camera device 124. These multimedia signals 59 may be analog signals, discrete time signals, or digital signals depending on particular form and format used by each device.

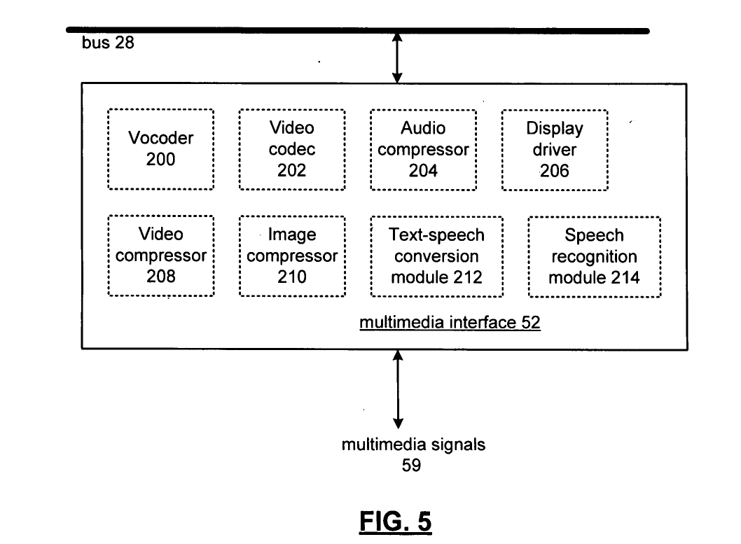

FIG. 5 presents a block diagram representation of a multimedia interface 52 in accordance with an embodiment of the present invention. In particular, multimedia interface 52 provides digital to analog conversion, analog to digital conversion, formats output signals sent to output devices of multimedia module 60 and processes input signals for coding, compression, storage and further processing by the various submodules of multimedia interface 52 and by the other modules of handheld device 80. The submodules of multimedia interface 52 optionally include one or more of the following: a vocoder 200 for digitizing voice signals, a video codec 202 for digitizing video signals, an audio compressor 204 for creating compressed audio files, a display driver 206 that generates a display signal for driving an internal or external display device, a video compressor 208 for creating compressed video files, an image compressor 210 for creating compressed image files, a text-to speech conversion module 212 for converting text data into to synthesized voice signals, and a speech recognition module 214 for recognizing the content of speech such as one or more spoken commands.

In an embodiment of the present invention, under the control of the processing module 20, the multimedia module 60 retrieves multimedia data from memory module 40. The multimedia data includes at least one of digitized audio data, digital video data, and text data. In a playback mode, upon retrieval of the multimedia data, the display driver 206 of multimedia module 60 converts the data into a display signal. For example, the multimedia module 60 may convert digitized data into analog signals that are subsequently rendered audible via a speaker or via a headphone jack. In addition, or in the alternative, the multimedia module 60 may render digital video data and/or digital. text data into RGB (red-green-blue), YUV, etc., data or analog signals for display on an LCD (liquid crystal display) monitor, OLED monitor, projection CRT, and/or on a plasma type display, such as display 120.

In a storage mode, the handheld device 80 may store digital information received via one of the input devices 118, 122 and 124. For example, a voice recording received via the microphone 122 may be digitized via the multimedia module 60 and digitally stored in memory module 40. Similarly, video recordings may be captured via the camera device 124 (e.g., a digital camera, a camcorder, VCR output, DVD output, etc.) and processed by the multimedia module 60 for storage as digital video data in memory module 40. Further, the keypad 118 (which may be a keyboard, touch screen interface, or other mechanism for accepting user commands and for inputting text information and to otherwise interface with the user of handheld device 80) provides text data to the multimedia module 60 for storage as digital text data in memory module 40 and user commands to change modes of operation of handheld device 80 and other commands and user selections.

In an embodiment of the present invention, the sponsor information includes sponsor data included in a data file, the data file further including program content data, and wherein the playback module 70 plays the program content and triggers the display driver 206 to generate a display signal that includes the sponsor data, in conjunction with the playback of the program content. For instance, as a song is being played, the display device 120 can display the title and artist of the song along with sponsor data such as the name of the sponsor, information on sponsor products, a message from the sponsor to the user or other sponsor selected text. Alternatively the sponsor data can include a still image, graphics, or video such as a video clip, and the display driver 206 generates a display signal that causes the display device 120 to display the sponsor data in a portion or window of display 120, as wallpaper or other background of display 120 or otherwise displayed in conjunction with the playback of the program content.

In an embodiment of the present invention, the sponsor information includes coupon information, such as a bar code, promotional code or coupon code corresponding to at least one sponsor product and the display driver 206 generates the display signal that includes the coupon information. Playing the digitally formatted file, such as the compressed audio file, allows the user obtain the coupon information to receive discounts, rebates or free samples for one or more sponsor products. The coupon information can be stored, printed directly from a printer attached to handheld device 80, transferred to a host device such as host device A or B for printing, or otherwise be recorded by the user for use in conjunction with the purchase of sponsor's products. Further, the display 120 of handheld device 80 can display a bar code of the coupon information that can be read by a scanner at a store in conjunction with the purchase of sponsor's products. In particular, the display device 120 of handheld device 80 is scanned in place of a coupon at the store, to yield the discounts or other benefits associated with the coupon information.

As will be understood by one skilled in the art when presented the disclosure herein, the multimedia module 60 may include less than the components shown in FIGS. 4 and 5. For instance, the multimedia module 60 may process audio, but not video data, or vice versa. Further, the multimedia module 60 can include further coding, decoding, formatting, encryption, decryption and signal processing modules than are specifically shown. In addition, multimedia module 60 can be implemented with audio and video inputs, in addition to the inputs that are expressly illustrated.

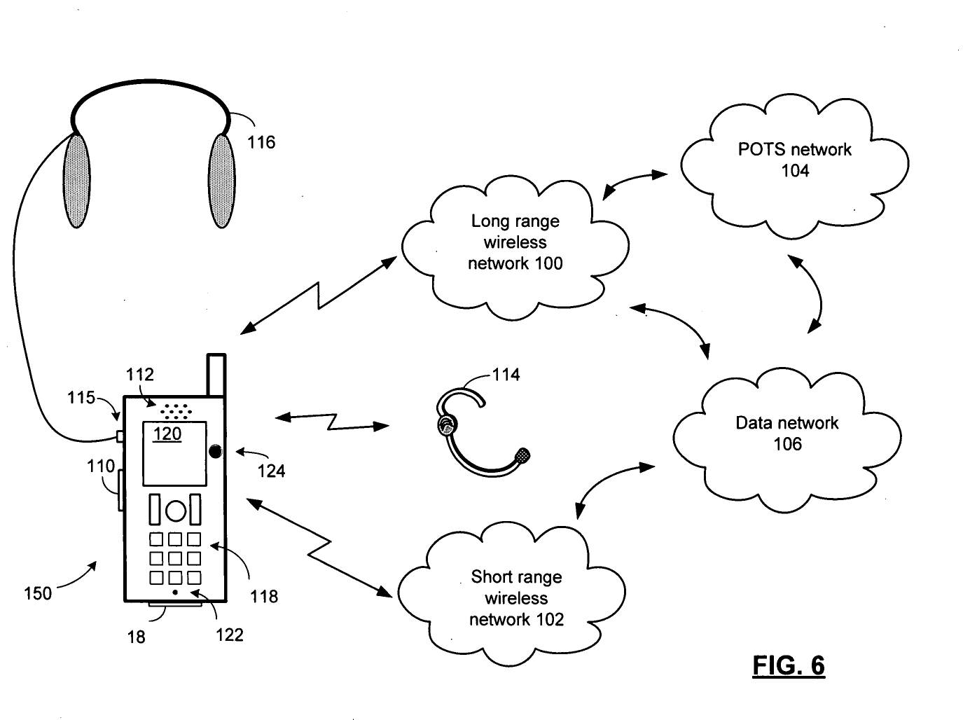

FIG. 6 presents a pictorial representation of a wireless handset 150 in accordance with an embodiment of the present invention. In particular, a wireless handset 150 provides a further example of handheld device 80 that includes one or more of the functions and features discussed in conjunction with FIGS. 1-5. In addition, wireless handset 150 communicates over a long range wireless network 100 that is operably coupled to the POTS network 104 and data network 106. Examples of such networks include wireless telephone networks that operate cellular, personal communications service (PCS), general packet radio service (GPRS), global system for mobile communications (GSM), and integrated digital enhanced network (iDEN). These networks are capable of accessing the plain old telephone service (POTS) network to send and receive telephone calls as well as broadband data networks that provide Internet access and enhanced services such as streaming audio and video, television service, voice-over-IP (VoIP) telephone service etc., in accordance with international wireless communications standards such as 2G, 2.5G and 3G. Further, data network 106 includes the Internet and short range wireless network 102 includes an access point that communicates with the wireless handset 150 via a radio frequency communications link such as 802.11x, Wimax, a wireless local area network connection of other communications link.

In this fashion, wireless handset 150 can also place and receive telephone calls, text messages such as emails, short message service (SMS) messages, pages and other data messages that may include multimedia attachments such as documents, audio files, video files, images and other graphics, can access the Internet through data network 106, can upload and download information including compressed audio and video files such as songs, movies, ringtones, and other multimedia data, and can play stored or streaming audio and/or video content. In particular, wireless handset 150 can access a wireless data network for downloading a plurality of files that include the digitally formatted file that includes sponsor information.

Wireless handset 150 includes internal audio input device such as microphone 122 and internal audio output device such as speaker 112. In addition, headphones 116 can optionally be connected via headphone jack 115. Wireless headset 114 further includes an audio input device and audio output device that are connected to wireless headset 150 by a short range wireless communications link that uses an infrared link such as IrDA, or a radio frequency communications link conforming to the Bluetooth standard. The user interface of wireless handset 150 includes a keypad 118 and a display device 120 for displaying graphics and text, and optionally providing an additional touch sensitive interface with soft keys and/or graphics input and or handwriting recognition.

Wireless handset optionally includes a camera 124 for capturing still and/or video images, removable memory card 100 for providing additional memory and removable storage, and an optional host interface 18 for uploading and downloading information directly to and from a host device such as host A or host B.

Additional features and functions of wireless handset 150 will be discussed in conjunction with the figures that follow.

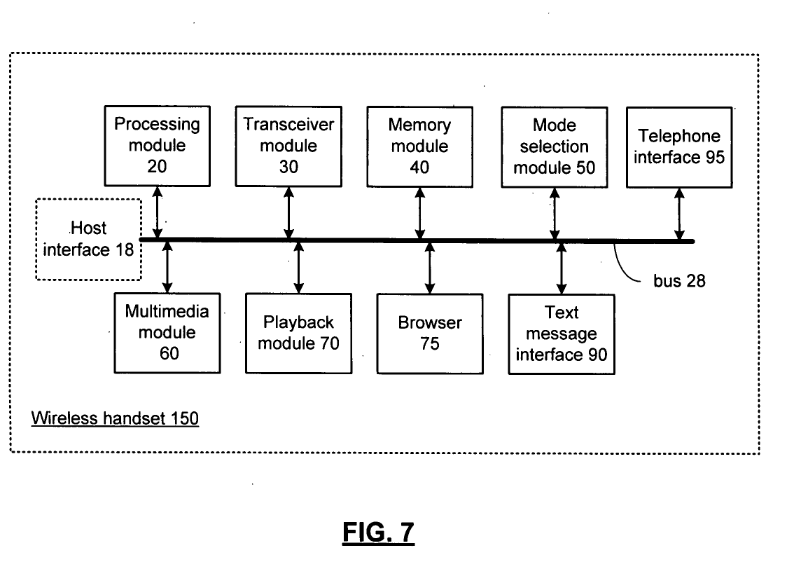

FIG. 7 presents a block diagram representation of wireless handset 150 in accordance with an embodiment of the present invention. In particular, wireless handset 150, like handheld device 80, includes a processing module 20 and memory module 40 that communicate via bus 28. In an embodiment of the present invention, processing module 20 includes a processor for executing a series of operational instructions such as system programs, application programs, and other routines. Wireless handset 150 includes or common elements from handheld device 80 that are referred to by common reference numerals. It should be noted that wireless handset 150 may or may not include host interface 18. In particular, wireless handset can optionally access the Internet or other data network via either short range wireless network 102 or long range wireless network 100 in order to transfer files by uploading or downloading or attachment to email or text messages, access streaming content, etc. In short, the function and features attributed to the interface between the handheld device 80 and the wireless handset 150, except for battery changing and power transfer options, can be effectuated with this alternative connection between the wireless handset and a remote server acting as the host.

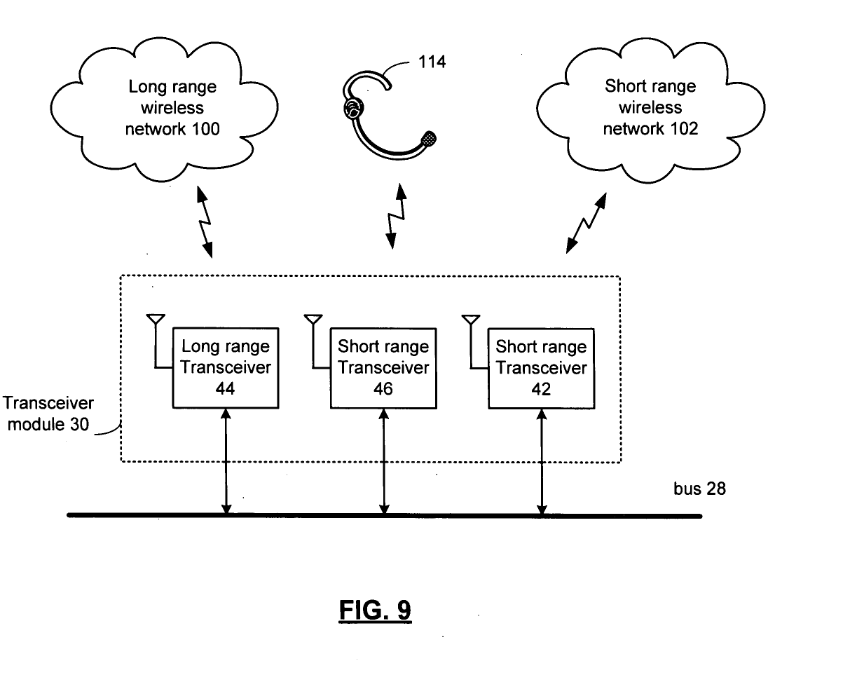

In addition, to the elements of handheld device 80, wireless handset 150 includes a transceiver module that is discussed in greater detail in conjunction with FIG. 9, telephone interface 95 that provides a user interface for access standard telephony features and/or VoIP telephony features of wireless handset 150, and a browser 75. In an embodiment of the present invention, browser 75 includes a plurality of operational instructions of software or firmware that are stored in memory module 40 and executed by processing module 20 to provide a graphical user interface for the user of wireless handset 150 to access data network 106. Browser 75 can include a Web browser that is configured to access websites, such as selected sites or other sites in a resolution that conforms to the resolution and size of the display device 120.

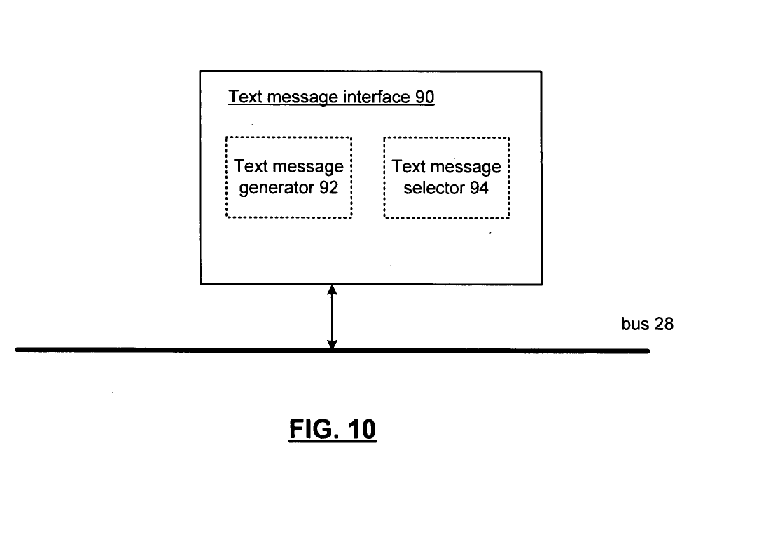

Text message interface 90 provides a user interface for retrieving, selecting and composing text messages, a transceiver module 30 that includes one or more transceivers, a mode selection module 50 for placing the wireless handset 150 in one or more operating modes, a multimedia module 60 for processing input and output, a playback module 70 for processing audio output, and a browser 75 for providing a user interface for Internet access and similar content for accessing streaming audio and streaming video content, and for downloading data files such as may be text files, presentation files, user profile information for access to varies various computer services (e.g., Internet access, email, etc.), digital audio files (e.g., MP3 files, WMA—Windows Media Architecture—, mp3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format. Like browser 75, text message interface 90 includes a plurality of operational instructions of software or firmware that are stored in memory module 40 and executed by processing module 20 to provide a graphical user interface for the user of wireless handset 150. Text message interface 90 is discussed in greater detail in conjunction with FIG. 10

Each of these modules may be implemented in hardware, firmware, software or a combination thereof, in accordance with the broad scope of the present invention. While a particular bus architecture is shown in FIG. 7, alternative bus architectures that include further connectivity, such as direct connectivity between the various modules, are likewise possible to implement the features and functions included in the various embodiments of the present invention.

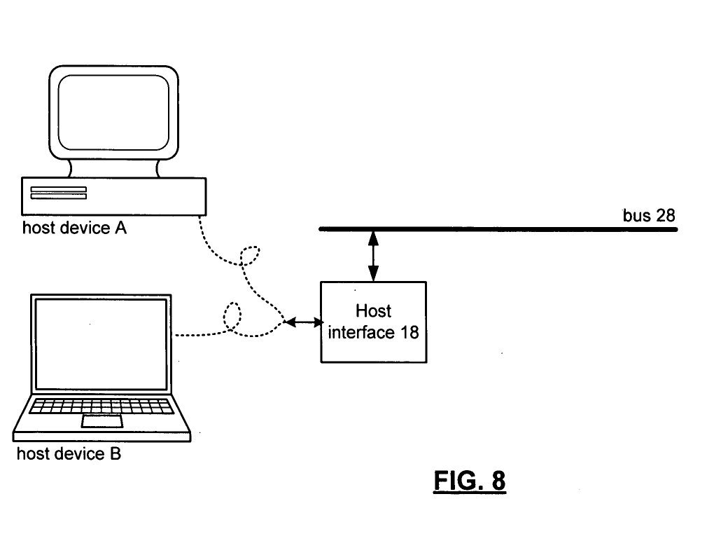

FIG. 8 presents a block/pictorial diagram of a host interface 18 in accordance with an embodiment of the present invention. In particular, the operation of wireless handset is described when optional host interface 18 is included. When the wireless handset 150 is operably coupled to a host device A, or B, the mode selection module 50 places the integrated circuit 12 in a host connected mode.

With the wireless handset 150 is in the host connected mode, the host interface 18 facilitates the transfer of data between the host device A or B and wireless handset 150. For example, data received from the host device A, or B is first received via the host interface 18. Depending on the type of coupling between the host device and the wireless handset 150, the received data will be formatted in a particular manner. For example, if the wireless handset is coupled to the host device via a USB cable, the received data will be in accordance with the format proscribed by the USB specification. The host interface 18 converts the format of the received data (e.g., USB format) into a desired format by removing overhead data that corresponds to the format of the received data and storing the remaining data as data words. The size of the data words generally corresponds directly to, or a multiple of, the bus width of bus 28 and the word line size (i.e., the size of data stored in a line of memory) of memory 16. Under the control of the processing module 20, the data words are provided to memory module 40 for storage. In this mode, the wireless handset 150 is functioning as extended memory of the host device (e.g., like a thumb drive).

In furtherance of the host connected mode, the host device may retrieve data from memory module 40 as if the memory were part of the computer. Accordingly, the host device provides a read command to the wireless handset 150, which is received via the host interface 18. The host interface 18 converts the read request into a generic format and provides the request to the processing module 20. The processing module 20 interprets the read request and coordinates the retrieval of the requested data from memory module 40. The retrieved data is provided to the host interface 18, which converts the format of the retrieved data from the generic format of the wireless handset 150 into the format of the coupling between the wireless handset and the host device. The host interface 18 then provides the formatted data to the host device via the coupling.

The coupling between the host device and the wireless handset 150 may be a wireless connection or a wired connection. For instance, a wireless connection, provided by transceiver module 30 may be in accordance with Bluetooth, IEEE 802.11x, and/or any other wireless LAN (local area network) protocol, IrDA, etc. implemented using transceiver module 30. The wired connection may be in accordance with one or more Ethernet protocols, Firewire, USB, etc. Depending on the particular type of connection, the host interface 18 includes a corresponding encoder and decoder. For example, when the wireless handset 150 is coupled to the host device via a USB cable, the host interface 18 includes a USB encoder and a USB decoder.

In an embodiment of the present invention, when the wireless handset 150 is coupled to the host device A or B via a wired connection or direct coupling, the host device may power the wireless device 150 such that the battery is unused and/or may further recharge the battery of wireless device 150. When the wireless handset 150 is uncoupled from the host device, the mode selection module 50 detects the disconnection and places the wireless handset in an alternative operational mode.

FIG. 9 presents block/pictorial representation of transceiver module 30 in accordance with an embodiment of the present invention. In an embodiment of the present invention, transceiver module 30 includes long range transceiver 44, and short range transceivers 42 and 46. Long range transceiver 44 provides access to long range wireless network 100, short range transceiver 42 provides access to short range wireless network 102 and short range transceiver 46 provides access to wireless peripheral devices such as host A or B when host interface 18 is implemented with a wireless connection, wireless headset 114, a wireless keyboard or other peripheral devices.

FIG. 10 presents a block diagram representation of a text message interface 90 in accordance with an embodiment of the present invention. In particular, text message interface 90 includes a text message generator 92 that allows a user to compose a text message, and a text message selector 94 that allows a user to select one or more text messages that have been received. In an embodiment of the present invention, text message interface 90 includes an inbox folder, sent message folder, draft message folder, trash folder, and addresses folder that allow a user to receive, review, forward and reply to a text message that is received and to draft, edit, address, and attach files to a text message that is sent.

FIG. 11 presents pictorial representation of several screen displays in accordance with an embodiment of the present invention. In particular screens 310, 312 and 314 present examples of display screens that can be used by a computer, such as host device A or B or directly by handheld device 80 or wireless handset 150 to download a digitally formatted file that includes sponsor information. In screen 310, a website of the sponsor Very Berry Cola, or a third party website, such as a website that specializes in content download, presents a user the option of downloading selected program content in a digitally formatted file that includes the sponsor information previously discussed.

Screen 312 differs from screen 310 by downloading the digitally formatted file in response to a user entering a valid prize code. In particular, either before, after or otherwise in conjunction with the selection of the program content, the user is prompted to enter in a prize code or other promotional code provided to the winner of a contest, sweepstakes, etc. The website reads the prize code and authenticates it as a valid code, and optionally that this particular code has not been used more than N times, where N is the number of allowable times a valid code is allowed to be used by the rules of the sweepstakes, contest, etc. When the code is authenticated the download of the program content is enabled. Otherwise, the website may prompt the user that an invalid code has been entered and to try again.

Screen 314 differs from screens 310 and 312 by charging the user, via account charge or debit, charge card, debit card, or other monetary transaction for the download of the program content. In particular, the user is charged less for downloading the program content with the sponsor information, compared to the cost of downloading the program content without the sponsor information. While a reduced price is shown, the digitally formatted file that includes the sponsor information can also be offered for free. In an embodiment of the present invention, the user is given the choice of downloading the program content, either with or without the sponsor information.

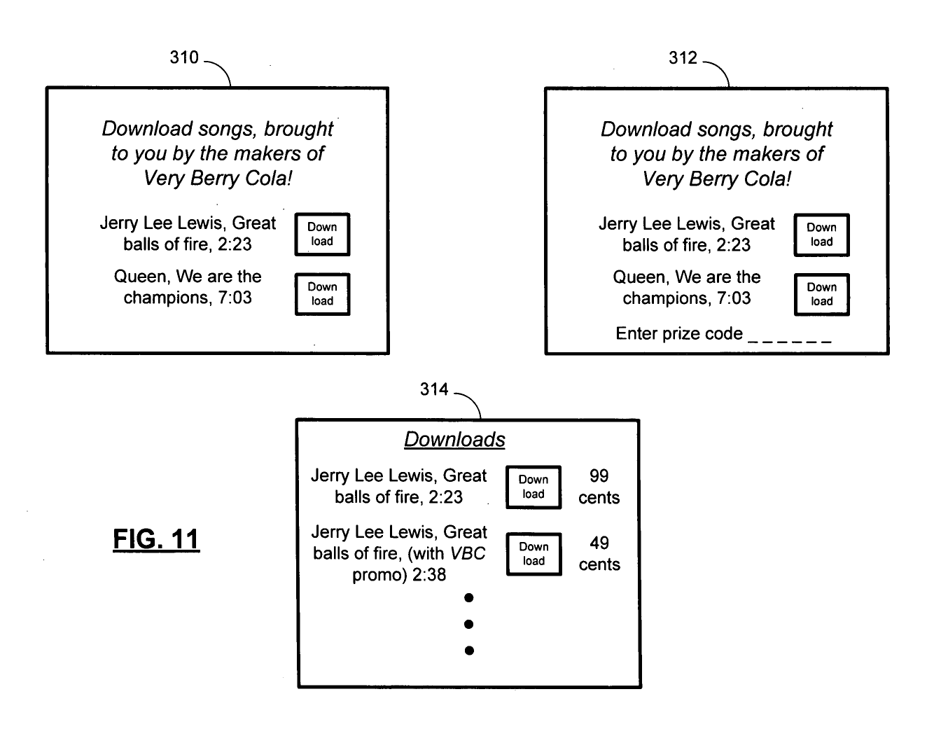

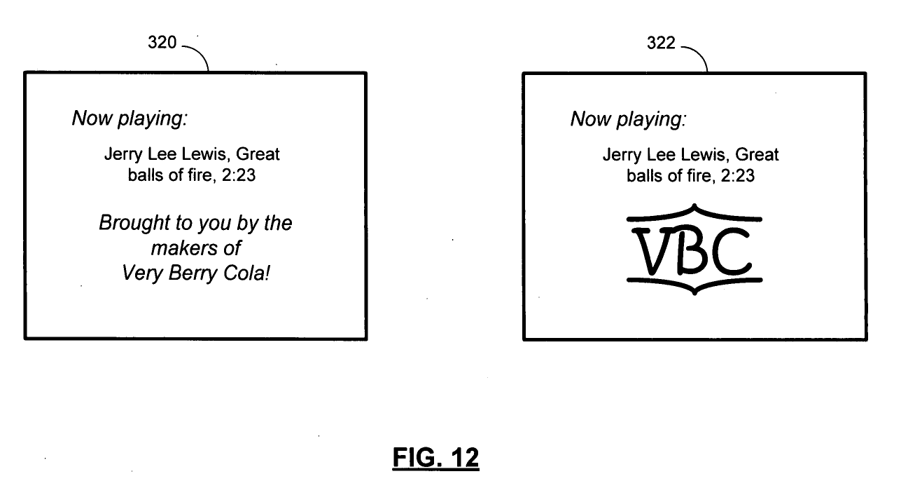

FIG. 12 presents pictorial representation of several screen displays in accordance with an embodiment of the present invention. In particular, screen displays 320 and 322 can be displayed on either handheld device 80 and/or wireless handset 150 during playback of a digitally formatted file that includes the program content shown, and related sponsor information. In screen 320, the message, “Brought to you by the makers of Very Berry Cola!” is displayed as test on display device 120, in conjunction with the artist and title of a song, as is played by handheld device 80 and/or wireless handset 150. In screen 322, the sponsor information includes a Very Berry Cola product logo that is displayed on display device 120 when the song is being played. It the sponsor information can likewise include a still image, such as a photo of a frothy mug of Very Berry Cola, or a video such as a video clip of an icy glass of Very Berry Cola being lovingly sipped by a beautiful model, etc.

FIG. 13 presents pictorial representation of several screen displays in accordance with an embodiment of the present invention. In particular, screens 300 and 302 are shown for display on a display device 120 of handheld device 80 or wireless handset 150. In these modes of operation, the sponsor information includes coupon information such as a bar code, coupon code or other promotional code. Screen 300 shows the display of a bar code on display 120 and screen 302 shows the display of a coupon code on display 120. In either case, this display may be used by the user to obtain a discount or other benefit in association with the purchase of products or services of the sponsor.

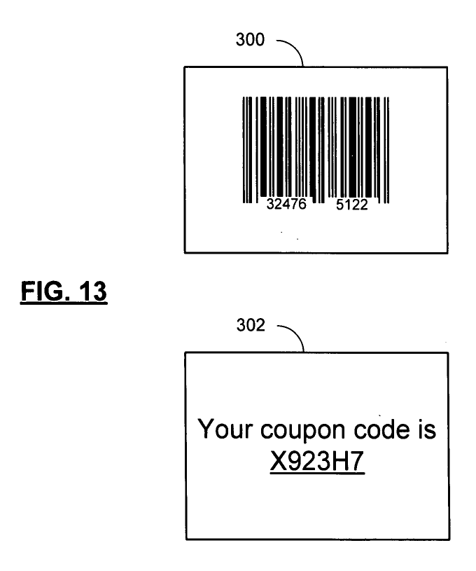

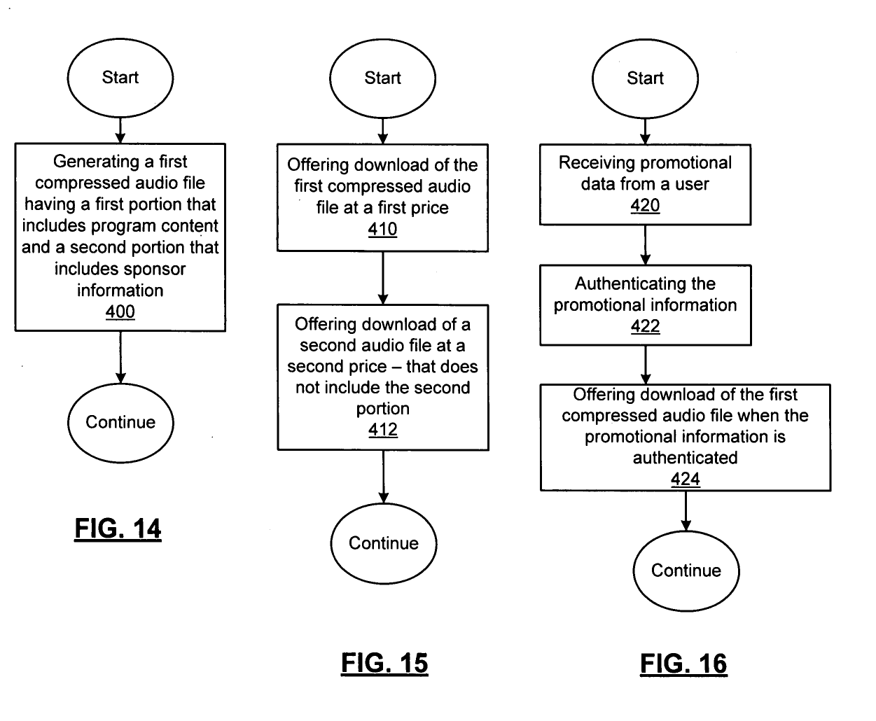

FIG. 14 presents a flowchart representation of a method in accordance with an embodiment of the present invention. In particular, a method is presented for use in conjunction with one or more of the functions and features described in conjunction with FIGS. 1-13. In step 400, a first compressed audio file is generated, the compressed audio file having a first portion that includes program content and a second portion that includes sponsor information.

In an embodiment of the present invention, the sponsor information includes sponsor data included in a data file, the data file further including program content data. The sponsor information can include an audio advertisement that is appended to the program content, the sponsor information can include compressed image data for display on a video display device, and can include coupon information corresponding to at least one sponsor product. In addition, the host device A or B or other remote server can query the handheld device to determine the screen resolution, video and/or other audio qualities to determine the proper compression format, resolution, etc., prior to step 400, for encoding the program content and/or the sponsor information in a manner so that they will be faithfully reproduced given the qualities of the player/display.

FIG. 15 presents a flowchart representation of a method in accordance with an embodiment of the present invention. In particular, a method is presented for use in conjunction with one or more of the functions and features described in conjunction with FIGS. 1-14. In step 410, download of the first compressed audio file is offered at a first price. In step 412, download of a second audio file is offered at a second price, the second audio file including the program content without the second portion, wherein the first price is less than the second price. In an embodiment of the present invention, step 410 includes offering download of the first compressed audio file for free.

FIG. 16 presents a flowchart representation of a method in accordance with an embodiment of the present invention. In particular, a method is presented for use in conjunction with one or more of the functions and features described in conjunction with FIGS. 1-15. In step 420, promotional data is received from a user. In step 422, the promotional information is authenticated. In step 424, download of the first compressed audio file is offered, when and in response to the promotional information being authenticated. In an embodiment of the present invention, the promotional data includes a promotional code, a coupon code or a-prize code.

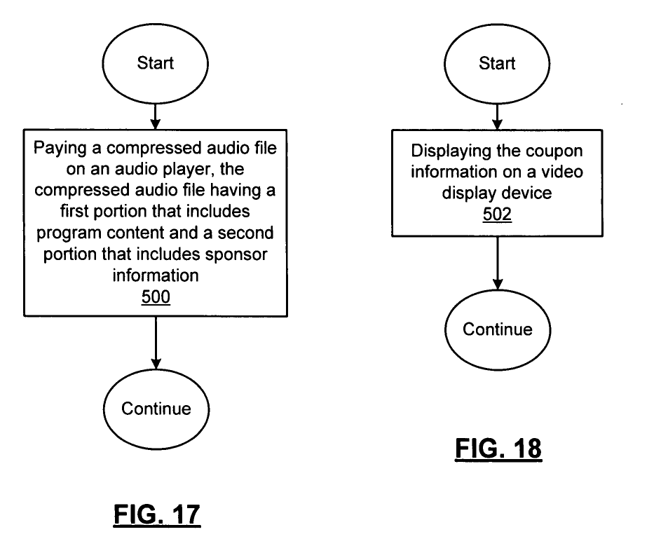

FIG. 17 presents a flowchart representation of a method in accordance with an embodiment of the present invention. In particular, a method is presented for use in conjunction with one or more of the functions and features described in conjunction with FIGS. 1-16. In step 500, a compressed audio file is played on an audio player, the compressed audio file having a first portion that includes program content and a second portion that includes sponsor information.

In an embodiment of the present invention, the sponsor information includes sponsor data included in a data file, the data file further including program content data, and wherein step 500 includes playing the program content and displaying the sponsor information in conjunction therewith. Further, the sponsor information can include an audio advertisement that is appended to the program content and step 500 can include playing the program content and playing the audio advertisement in conjunction therewith. Also, the sponsor information can include image data for display on a video display device and step 500 can include playing the program content and displaying the image data on the video display device in conjunction therewith. The image data can include a still image and/or a video clip.

FIG. 18 presents a flowchart representation of a method in accordance with an embodiment of the present invention. In particular, a method is presented for use in conjunction with one or more of the functions and features described in conjunction with FIG. 17. In step 502, the sponsor information includes coupon information corresponding to at least one sponsor product and the method further includes displaying the coupon information on a video display device. In an embodiment of the present invention, step 502 includes displaying a bar code, a promotional code, and/or a coupon code. In an embodiment of the present invention Step 502 is enabled in response to playing the second portion.

While the description above has set forth several different modes of operation, the wireless handset 150 may simultaneously be in two or more of these modes, unless, by their nature, these modes necessarily cannot be implemented simultaneously.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

In preferred embodiments, the various circuit components are implemented using 0.35 micron or smaller CMOS technology and can include one or more system on a chip integrated circuits that implement any combination of the devices, modules, submodules and other functional components presented herein. Provided however that other circuit technologies including other transistor, diode and resistive logic, both integrated or non-integrated, may be used within the broad scope of the present invention. Likewise, various embodiments described herein can also be implemented as software programs running on a computer processor. It should also be noted that the software implementations of the present invention can be stored on a tangible storage medium such as a magnetic or optical disk, read-only memory or random access memory and also be produced as an article of manufacture.

Thus, there has been described herein an apparatus and method, as well as several embodiments including a preferred embodiment, for implementing a wireless handset. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A handheld device comprising:
a memory that stores a compressed audio file the compressed audio file having a first portion that includes program content and a second portion that includes sponsor information; and
a playback module, coupled to the memory, that plays the compressed audio file by generating an analog audio signal.

2. The handheld device of claim 1 wherein the sponsor information includes an audio advertisement that is appended to the program content and wherein the playback module plays the program content and plays the audio advertisement in conjunction therewith.

3. The handheld device of claim 1 further comprising:
a display driver, coupled to the memory, that generates a display signal; and
a display device, coupled to the display driver, that generates a display based on the display signal.

4. The handheld device of claim 3 wherein the sponsor information includes sponsor data included in a data file, the data file further including program content data, and wherein the playback module plays the program content and the display driver generates the display signal that includes the sponsor data, in conjunction therewith.

5. The handheld device of claim 3 wherein the sponsor information includes image data and wherein the playback module plays the program content and the display driver generates the display signal that includes sponsor data in conjunction therewith.

6. The handheld device of claim 5 wherein the image data includes one of a still image and a video clip.

7. The handheld device of claim 4 wherein the sponsor information includes coupon information corresponding to at least one sponsor product and the display driver generates the display signal that includes the coupon information.

8. The handheld device of claim 7 wherein the coupon information includes one of a bar code, a promotional code, and a coupon code.

9. The handheld device of claim 1 further comprising a host interface, coupled to the memory, that can be selectively coupled to the host device for downloading a plurality of files that include the compressed audio file.

10. The handheld device of claim 1 further comprising a transceiver module, coupled to the memory, that can access a wireless data network for downloading a plurality of files that include the compressed audio file.

11. An integrated circuit comprising:
a memory that stores a compressed audio file the compressed audio file having a first portion that includes program content and a second portion that includes sponsor information; and
a playback module, coupled to the memory, that plays the compressed audio file by generating an analog audio signal.

12. The integrated circuit of claim 11 wherein the sponsor information includes an audio advertisement that is appended to the program content and wherein the playback module p lays the program content and plays the audio advertisement in conjunction therewith.

13. The integrated circuit of claim 11 further comprising:
a display driver, coupled to the memory, for driving a display device.

14. The integrated circuit of claim 13 wherein the sponsor information includes sponsor data included in a data file, the data file further including program content data, and wherein the playback module plays the program content and the display driver generates a display signal that includes the sponsor data, in conjunction therewith.

15. The integrated circuit of claim 13 wherein the sponsor information includes image data and wherein the playback module plays the program content and the display driver generates a display signal that includes sponsor data in conjunction therewith.

16. The integrated circuit of claim 15 wherein the image data includes one of a still image and a video clip.

17. The integrated circuit of claim 14 wherein the sponsor information includes coupon information corresponding to at least one sponsor product and the display driver generates a display signal that includes the coupon information.

18. The integrated circuit of claim 17 wherein the coupon information includes one of a bar code, a promotional code, and a coupon code.

19. A method comprising:
generating a first compressed audio file, the compressed audio file having a first portion that includes program content and a second portion that includes sponsor information.

20. The method of claim 19 wherein the sponsor information includes sponsor data included in a data file, the data file further including program content data.

21. The method of claim 19 wherein the sponsor information includes an audio advertisement that is appended to the program content.

22. The method of claim 19 wherein the sponsor information includes compressed image data for display on a video display device.

23. The method of claim 19 wherein the sponsor information includes coupon information corresponding to at least one sponsor product.

24. The method of claim 19 further comprising:
offering download of the first compressed audio file at a first price;
offering download of a second audio file at a second price, the second audio file including the program content without the second portion;
wherein the first price is less than the second price.

25. The method of claim 24 wherein the step of offering download of the first compressed audio file includes offering download of the first compressed audio file for free.

26. The method of claim 19 further comprising:
receiving promotional data from a user;
authenticating the promotional information; and
offering download of the first compressed audio file, when the promotional information is authenticated.

27. The method of claim 26 wherein the promotional data includes one of a promotional code, a coupon code, and a prize code.

28. A method comprising:
playing a compressed audio file on an audio player, the compressed audio file having a first portion that includes program content and a second portion that includes sponsor information.

29. The method of claim 28 wherein the sponsor information includes sponsor data included in a data file, the data file further including program content data, and wherein the step of playing the compressed audio file includes playing the program content and displaying the sponsor information in conjunction therewith.

30. The method of claim 28 wherein the sponsor information includes an audio advertisement that is appended to the program content and wherein the step of playing the compressed audio file includes playing the program content and playing the audio advertisement in conjunction therewith.

31. The method of claim 28 wherein the sponsor information includes image data for display on a video display device and wherein the step of playing the compressed audio file includes playing the program content and displaying the image data on the video display device in conjunction therewith.

32. The method of claim 31 wherein the image data includes one of a still image and a video clip.

33. The method of claim 28 wherein the sponsor information includes coupon information corresponding to at least one sponsor product and the method further comprises:
displaying the coupon information on a video display device.

34. The method of claim 33 wherein the step of displaying the coupon information includes one of displaying a bar code, a promotional code, and a coupon code.

35. The method of claim 34 wherein the step of displaying the coupon information is enabled in response to playing the second portion.
